(19) United States
(12) Patent Application Publication
(10) Pub. No.: US 2014/0218648 A1
(43) Pub. Date: Aug. 7, 2014

(54) DEVICE FOR THE POLARIZATION OF A VIDEO SEQUENCE TO BE VIEWED IN STEREOSCOPY

(71) Applicant: Stephen Palmer, Lyon (FR)

(72) Inventor: Stephen Palmer, Lyon (FR)

(73) Assignee: VOLFONI R&D, Paris (FR)

(21) Appl. No.: 14/235,899

(22) PCT Filed: Jul. 18, 2012
(86) PCT No.: PCT/EP2012/064069

§ 371 Date: Apr. 7, 2014

(30) Foreign Application Priority Data
Jul. 29, 2011 (FR) 1156941

(51) Int. Cl. G02B 27/26; H04N 13/04

(52) U.S. Cl. CPC G02B 27/26; H04N 13/0438
USPC 349/15; 359/465; 353/8

(57) ABSTRACT

A device for polarization of a video sequence to be stereoscopically viewed has a beam splitter, cells, mirrors, and a control circuit. The beam splitter receives an incident beam and separates it into two beams with perpendicular polarizations. It has four prisms, each with perpendicular faces. The first face of each prism has a phase-delaying plate, and the second face of each prism has a layer that reflects the first polarization and transmits the second. The prisms are arranged such that a first face of each prism is next to a second of an adjacent prism. The cells have variable polarization rotation and are crossed by the beams. Each mirror reflects a beam. The control circuit defines a polarization rotation of the cells such that the beams, after having crossed corresponding cells, have a common polarization that alternates between two perpendicular states.

### RELATED APPLICATIONS

This application is the national stage entry under §371 of PCT/EP2012/064069, filed on Jul. 18, 2012 which claims the benefit of the Jul. 29, 2011 priority date of French application 1156941.

### FIELD OF INVENTION

The invention relates to the display of stereoscopic video sequences, and in particular the display of stereoscopic video sequences in temporal multiplexing visible with passive glasses.

### BACKGROUND

The display of stereoscopic video sequences in cinemas generally uses the alternate projection of two video sub-sequences taken at separate viewing angles. The two video sub-sequences are therefore temporally multiplexed. A first video sequence is thus intended for the left eye, a second video sequence being intended for the right eye, thus creating an impression of relief. The sampling frequency imposed by the cinema standard for a video sequence being greater than 48 Hz (so that the rate of progression of the images is not perceptible by the eye), the projection frequency on a cinema screen is of at least 96 Hertz because each eye must see only the sequence that is intended therefor.

In a known operating mode, a high-speed video projector is used to emit the two sub-sequences in alternation without any particular polarization. According to the principle described in the U.S. Pat. No. 7,857,455, the light from the projector is separated into two beams with orthogonal polarizations in a beam splitter. The beam splitter is transmissive for the light with a first polarization, and reflective for the light with a second polarization. Thus two light paths are formed. Polarization modulators are arranged on the two light paths. The beam reflected by the splitter is sent back onto a mirror and superimposed on a screen with the beam having crossed the splitter. The screen is, for example, a metallized screen configured for reflecting the projected images while conserving the polarization of the latter.

For the first sub-sequence, the polarization modulators are controlled so that the beams of the two light paths have a polarization called P on the screen. For the second sub-sequence, the polarization modulators are controlled so that the beams of the two light paths have a polarization called S on the screen. The polarizations P and S are perpendicular. The polarization modulators are thus synchronized with the sub-sequences emitted by the projector. Thus, the two sub-sequences are displayed in alternation on the screen 4 with perpendicular linear polarizations.

The user himself possesses passive polarized stereoscopic glasses. In practice, a first lens of the glasses possesses a transmissive filter for the polarization S. This filter blocks the first sub-sequence and is transmissive for the second sub-sequence. The second lens of the glasses possesses a transmissive filter for the polarization P. This filter is transmissive for the first sub-sequence and blocks the second sub-sequence. Thus, each eye views only the sub-sequence that is intended for it.

This type of display has the advantage of relying on glasses that are particularly simple and not very sensitive to damage, which is a useful feature for glasses that are to be used by the public.

The device described in this patent makes it possible to obtain a high brightness for a given projector power. However, the image seen by the user has insufficient sharpness and the polarization device has a relatively high cost as well as being complicated to focus. Indeed, to compensate for an inequality in length between the two optical paths, this patent relies on a deformation of the reflective mirror to improve the superimposition of the two beams on the screen.

### SUMMARY

The invention aims to solve one or more of these drawbacks. The invention thus relates to a device for the polarization of a video sequence to be viewed in stereoscopy, the device comprising: a beam splitter intended to receive an incident light beam so as to separate it into first and second beams with first and second perpendicular polarizations respectively, the beam splitter having four prisms each having first and second perpendicular faces, the first face of each prism having a phase-delaying plate, the second face of each prism having a layer reflecting light with the first polarization and transmitting light with the second polarization, the four prisms being arranged so that the first face of each prism is placed next to the second face of an adjacent prism; first and second cells with variable polarization rotation, respectively crossed by the first and second beams output by the beam splitter; a control circuit defining the polarization rotation of the first and second cells so that the first and second beams having crossed the first and second cells respectively have one and the same polarization simultaneously, and so that this same polarization alternates between two perpendicular states; and first and second mirrors respectively reflecting the first and second beams output by the beam splitter.

In a variant, the prisms have a right-angle triangle section.

In another variant, the beam splitter and the mirrors are configured so that the light path of the first and second beams is symmetrical with respect to a plane.

In another variant, the first and second mirrors reflect the first and second beams in the direction of the incident beam

In yet another variant, the prisms each have an edge arranged in a plane including the optical axis of the beam splitter.

In a variant, the delay plates are half-wave plates, the optical axis of which is inclined at 45° relative to to the first polarization.

In another variant, the control circuit controls the alternation of polarization at a frequency greater than 50 Hz, and preferably less than 250 Hz.

In yet another variant, the cells with variable polarization rotation are liquid crystal cells.

In a variant, the cells with variable polarization rotation are interposed between the beam splitter and the mirrors.

The invention also relates to a system for projecting a video sequence to be viewed in stereoscopy, the system comprising a device as described above, a projection device, the optical axis of which is merged with the optical axis of the beam splitter, and a polarization conservation screen intersecting the first and second beams reflected by the mirrors.

### BRIEF DESCRIPTION OF THE DRAWINGS

Other characterizing features and advantages of the invention will appear clearly from the description of them below, for information purposes and in no way limiting, with reference to the appended drawings, in which:

FIG. 1 is a schematic representation of a viewing system in stereoscopy according to one embodiment of the invention;

FIG. 2 is a schematic representation of a section of a polarization device and of light rays crossing it;

FIG. 3 is a schematic representation of a section of various optical components of the polarization device;

FIG. 4 is a schematic representation of the light beams and their polarization for a first video sub-sequence; and

FIG. 5 is a schematic representation of the light beams and their polarizations for a second video sub-sequence.

### DETAILED DESCRIPTION

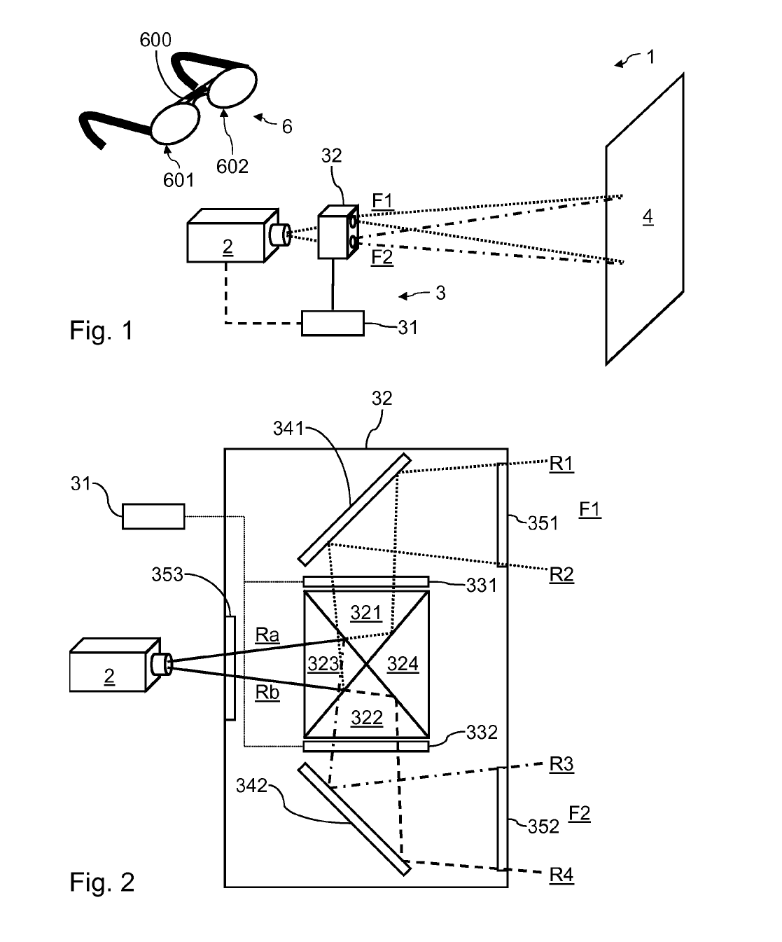

FIG. 1 is a schematic representation of a stereoscopic display system 1 in which the invention is implemented. The display system 1 comprises a high-speed projector 2, capable of projecting images at a frequency greater than 50 Hz (generally 144 Hz). The projector 2 can thus project a stereoscopic sequence. The projector 2 thus projects in temporal multiplexing two video sub-sequences of the stereoscopic sequence. The light at the output of the projector 2 does not have any particular polarization, the projector 2 forming an incoherent light source. The luminous flux can cross a collimating lens inside the projector 2.

A stereoscopic polarization device 3 is connected to the projector 2. The projector 2 transmits a synchronization signal to a control module 31 of the polarization device. The stereoscopic sequence projected by the projector 2 crosses a polarization module 32, which is intended to differentiate the two video sub-sequences by generating respective perpendicular polarizations. The light output by the projector 2 thus crosses the polarization module 32. The polarization module 32 forms two beams F1 and F2 with one and the same polarization. The polarization of the beams F1 and F2 changes alternatively between two perpendicular states, respectively called “p” and “s” in the following text. The beams F1 and F2 are projected in superimposition onto a screen 4. The metallized screen 4 has the property of reflecting the luminous flux by conserving the same polarization as the incident luminous flux.

A spectator equipped with so-called passive stereoscopic glasses 6 views the video sequence in stereoscopy. The glasses 6 have a frame 600 on which first and second passive shutters 601 and 602 are mounted. The first shutter 601 has a transparent lens surmounted by a transmissive linear polarizer for the polarization “P”, and the second shutter 602 has a transparent lens surmounted by a transmissive linear polarizer for the polarization “S”. Thus, each lens is transmissive for the video sub-sequence that is intended therefor, and each lens is shuttering for the video sub-sequence not intended therefor.

FIG. 2 is a schematic representation of a section of the polarization module 32 and of the light beams crossing it. The polarization module 32 comprises a box in which various optical components are housed. The polarization module 32 comprises a beam splitter equipped with prisms 321 to 324. The optical axis of the beam splitter is defined by the perpendicular to the input faces of the prisms 323 and 324 and passing by a common edge between the prisms 321 to 324. The optical axis of the beam splitter is merged with the optical axis of the projector 2. The polarization module 32 also comprises polarization modulators 331 and 332. The polarization modulators 331 and 332 are arranged horizontally, symmetrically on either side of the beam splitter. The polarization at the output of the polarization modulators 331 and 332 is controlled by way of the control circuit 31. The polarization module 32 also comprises reflective mirrors 341 and 342. The reflective mirrors 341 and 342 are inclined and arranged symmetrically with respect to the beam splitter. The polarization modulator 331 is arranged between the prism 321 and the mirror 341. The polarization modulator 332 is arranged between the prism 322 and the mirror 342. The polarization module 32 further comprises output windows 351 and 352. The output windows 351 and 352 are arranged in vertical planes and face the mirrors 341 and 342 respectively.

The beam splitter is configured for separating the incoherent light originating from the projector 2 into two beams having polarizations P and S respectively.

For a first ray Ra arriving at the interface between the prisms 321 and 323, the light decomposes into a ray R1 crossing this interface and a ray R3 reflected by this interface. At the interface, the P-polarized part of the ray Ra is transmitted, whereas the S-polarized part of the ray is reflected.

For a second ray Rb arriving at the interface between the prisms 322 and 323, the light decomposes into a ray R4 crossing this interface and a ray R2 reflected by this interface. At the interface, the P-polarized part of the ray Rb is reflected, whereas the S-polarized part of this ray is transmitted.

The reflected and P-polarized ray R2 is transmitted by the interface between the prisms 321 and 323. The transmitted and P-polarized ray R1 is reflected at the interface between the prisms 321 and 324. The rays R1 and R2 cross the polarization modulator 331 and reach the mirror 341. The rays R1 and R2 are reflected by the mirror 341 and cross the output window 351. A first light beam F1 is thus formed at the output of the window 351.

The reflected and S-polarized ray R3 is transmitted by the interface between the prisms 322 and 323. The transmitted and S-polarized ray R4 is reflected at the interface between the prisms 322 and 324. The rays R3 and R4 cross the polarization modulator 332 and reach the mirror 342. The rays R3 and R4 are reflected by the mirror 342 and cross the output window 352. A second light beam F2 is thus formed at the output of the window 352.

The beam splitter generates two light beams perpendicular to the incident beam. The mirrors 341 and 342 reflect these beams so that the beams F1 and F2 projected onto the screen 4 are parallel with the incident beam.

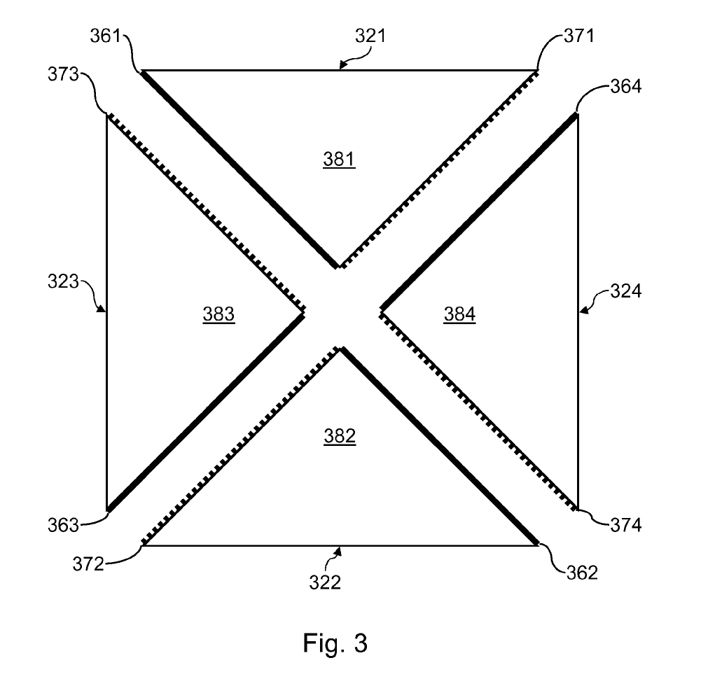

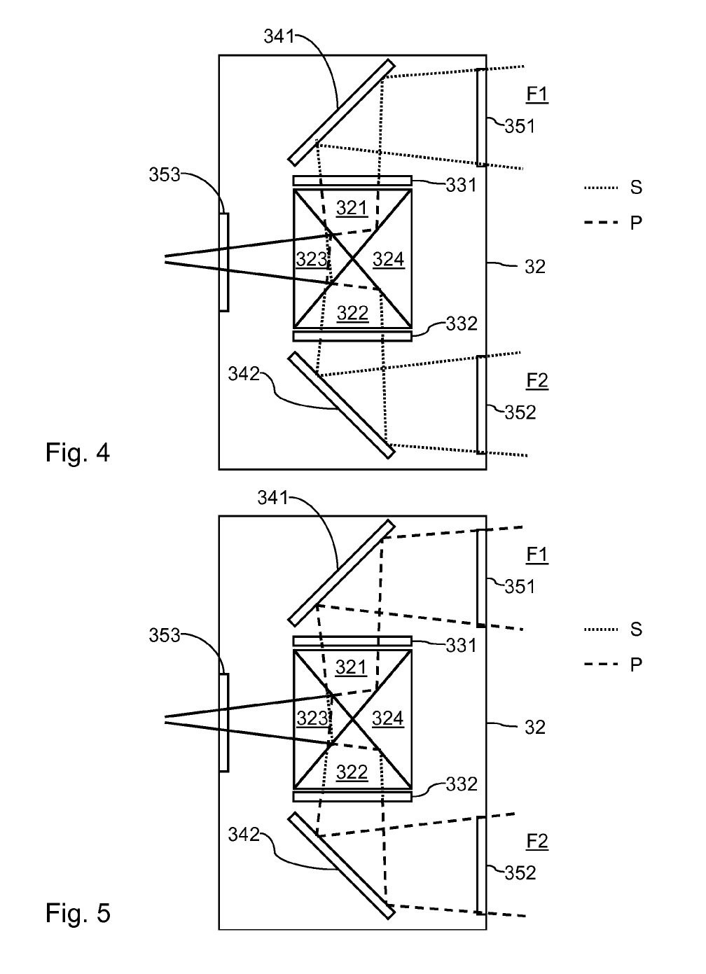

FIG. 3 is a schematic representation of a section of the structure of an example of a beam splitter being able to be incorporated into the polarization module 32. The prisms 321 to 324 have respective transparent elements 381 to 384. The transparent elements 381 to 384 have a cross section in the shape of a right-angle triangle. The transparent elements 381 to 384 are, for example, made of glass or from any other transparent and optically neutral material, for example a synthetic material. The prisms 321 to 324 are fixed together, for example, by way of an index adaptation sealant.

The prism 321 has a polarization separation layer 371 on a first face of the transparent element, and a plate of half-wave type 361 on a second face. The polarization separation layer 371 is reflective for the polarization P and transmissive for the polarization S. A plate of half-wave type induces a phase delay of 180° to the polarization along its slow axis. The optical axis of the plate 361 (its fast axis) is inclined at 45° with respect to the direction of polarization S.

The prism 322 has a polarization separation layer 372 on a first face of the transparent element, and a plate of half-wave type 362 on a second face. The polarization separation layer 372 is reflective for the polarization P and transmissive for the polarization S. A plate of half-wave type induces a phase delay of 180° to the polarization along its slow axis. The optical axis of the plate 362 is inclined at 45° with respect to the direction of polarization S.

The prism 323 has a polarization separation layer 373 on a first face of the transparent element, and a plate of half-wave type 363 on a second face. The polarization separation layer 373 is reflective for the polarization P and transmissive for the polarization S. A plate of half-wave type induces a phase delay of 180° to the polarization along its slow axis. The optical axis of the plate 363 is inclined at 45° with respect to the direction of polarization S.

The prism 324 has a polarization separation layer 374 on a first face of the transparent element, and a plate of half-wave type 364 on a second face. The polarization separation layer 374 is reflective for the polarization P and transmissive for the polarization S. A plate of half-wave type induces a phase delay of 180° to the polarization along its slow axis. The optical axis of the plate 364 is inclined at 45° with respect to the direction of polarization S.

Thus:
the P-polarized part of the ray Ra is reflected off the layer 373, S-polarized by crossing the plate 363, and transmitted by the separation layer 372. The ray R3 therefore reaches the polarization modulator 332 with a polarization S;
the S-polarized part of the ray Ra is transmitted by the layer 373, P-polarized by crossing the plate 361, and reflected by the separation layer 371. The ray R1 therefore reaches the polarization modulator 331 with a polarization P;
the P-polarized part of the ray Rb, having crossed the plate 363, is reflected off the layer 372, S-polarized by crossing the plate 363, transmitted by the separation layer 373 and P-polarized by the plate 361. The ray R2 therefore reaches the polarization modulator 331 with a polarization P;
the S-polarized part of the ray Rb ,having crossed the plate 363, is transmitted by the layer 372, P-polarized by crossing the plate 362, reflected by the separation layer 374, and S-polarized by crossing the plate 362 again. The ray R4 therefore reaches the polarization modulator 332 with a polarization S.

For a sub-sequence intended for the left eye, the control module 31 commands the polarization modulator 331 to transform the polarization P of the rays R1 and R2 into polarization S by applying an adequate polarization rotation. The rays R1 and R2 reflected off the mirror 341, exiting the window 351 and applied to the screen 4 therefore have a polarization S. The control module 31 commands the polarization modulator 332 to maintain the polarization S of the rays R3 and R4. The rays R3 and R4 reflected off the mirror 342, exiting the window 352, and applied to the screen 4 therefore have a polarization S. The beams F1 and F2 thus have one and the same polarization S arriving on the screen 4. This polarization S is visible through the shutter 602 of the glasses 6.

For a sub-sequence intended for the right eye, the control module 31 commands the polarization modulator 332 to transform the polarization S of the rays R3 and R4 into polarization P by applying an adequate polarization rotation. The rays R3 and R4 reflected off the mirror 342, exiting the window 352 and applied to the screen 4 therefore have a polarization P. The control module 31 commands the polarization modulator 331 to maintain the polarization P of the rays R1 and R2. The rays R1 and R2 reflected off the mirror 341, exiting the window 351 and applied to the screen 4 therefore have a polarization P. The beams F1 and F2 thus have one and the same polarization P arriving on the screen 4. This polarization P is visible through the shutter 601 of the glasses 6.

By virtue of the symmetry of the optical system of the polarization module 32, the beams F1 and F2 are superimposed on the screen 4 after having travelled one and the same distance. Thus, the sharpness of the image formed on the screen 4 is optimal. Furthermore, the optical system of the polarization module 32 does not necessitate the application of a mechanical deformation to any mirror, the sharpness of the image being thus optimized for reduced cost and complexity. Furthermore, the brightness of the video sequence on the screen 4 is optimal for a given light power of the projector 2. Indeed, the polarization module 32 does not necessitate the use of a linear polarizer, which does not induce a high light absorption.

The polarization separation layers 371 to 374 can be implemented in the form of dielectric coatings of so-called MacNeille type. These coatings can be formed by a stack of layers that alternate between a high refractive index and a lower refractive index (for example alternating indices of 2.1 and 1.62 for transparent elements 381 to 384 with a refractive index of 1.815). The polarization separation layers 371 to 374 can also be implemented in the form of networks of grids.

The half-wave plates 361 to 364 are formed from a material having adequate birefringence properties.

The polarization modulators 331 and 332 are typically formed from liquid crystal cells. Such liquid crystal cells are voltage-controlled to selectively apply either no polarization rotation or a polarization rotation of 90° to the light rays crossing them.

The polarization module 32 advantageously comprises a transmissive thermal screen 353 at its input. This thermal screen 353 makes it possible to limit the heating of the polarization module 32 due to the infrared radiation from the projector 2 arranged nearby.

The invention has been described for an example in which the beams F1 and F2 have a linear polarization analyzed by the shutters of the glasses 6. However, the invention can also be implemented by forming the beams F1 and F2 with circular polarizations, by placing a quarter-wave plate in front of the output 351 and a second quarter-wave plate in front of the output 352 (these plates being oriented at 45° to the polarization axis of the beams exiting the polarization modulators) and by equipping the glasses 6 with the corresponding quarter-wave plates.

1-10. (canceled)

11. An apparatus for use in stereoscopic viewing, said apparatus comprising a device for polarization of a video sequence to be stereoscopically viewed, said device comprising a beam splitter, first and second cells, first and second mirrors, and a control circuit, wherein said beam splitter is configured to receive an incident light beam and to separate said incident light beam into a first beam and a second beam, wherein said first beam has a first polarization and said second beam has a second polarization, wherein said first and second polarizations are perpendicular, wherein said beam splitter comprises four prisms, wherein each prism has first and second perpendicular faces, wherein said first face of each prism comprises a phase-delaying plate, wherein said second face of each prism has a layer that reflects light of said first polarization and that transmits light of said second polarization, wherein said four prisms are arranged such that a first face of each prism is placed next to a second face of an adjacent prism, wherein said first and second cells have variable polarization rotation, wherein said first and second cells are crossed by said first and second beams, which are output by said beam splitter, wherein said first mirror reflects said first beam, which is output by said beam splitter, wherein said second mirror reflects said second beam, which is output by said beam splitter, wherein said control circuit defines a polarization rotation of said first and second cells such that said first and second beams, after having crossed said corresponding first and second cells, have a common polarization, and wherein said control circuit is further configured to cause said common polarization to alternate between two perpendicular states.

12. The apparatus of claim 11, wherein said prisms comprise a right-angle triangle section.

13. The apparatus of claim 11, wherein said beam splitter and said mirrors are configured so that a light path of said first beam and a light path of said second beams are symmetrical with respect to a plane.

14. The apparatus of claim 11, wherein said incident beam is along a first direction, and wherein first and second mirrors are configured to reflect said first and second beams in said first direction.

15. The apparatus of claim 11, wherein said beam splitter has an optical axis, and wherein said prisms each have an edge arranged in a plane that includes said optical axis of said beam splitter.

16. The apparatus of claim 11, wherein said delay plates are half-wave plates, the optical axes of which are inclined at 45° with respect to the first polarization.

17. The apparatus of claim 11, wherein said control circuit is configured to control alternation between said two perpendicular states at a frequency between 50 Hz and 250 Hz.

18. The apparatus of claim 11, wherein said first and second cells are liquid crystal cells.

19. The apparatus of claim 11, wherein said first and second cells are interposed between said beam splitter and said mirrors.

20. The apparatus of claim 11, wherein said beam splitter has an optical axis, and wherein said apparatus further comprises a projection device and a polarization conservation screen, wherein said projection devices has an optical axis that is merged with said optical axis of said beam splitter, and wherein said polarization conservation screen is disposed to intersect said first and second beams reflected by said first and second mirrors, whereby said apparatus is configured for projecting a video sequence to be stereoscopically viewed.
